(19) United States
(12) Patent Application Publication
(10) Pub. No.: US 2009/0099812 A1
(43) Pub. Date: Apr. 16, 2009

(54) Method and Apparatus for Position-Context Based Actions

(76) Inventors: Philippe Kahn, Aptos, CA (US); Arthur Kinsolving, Santa Cruz, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/871,151

(22) Filed: Oct. 11, 2007

(51) Int. Cl. G06F 15/00

(52) U.S. Cl. 702/152

(57) ABSTRACT

A method and apparatus for utilizing acceleration data to identify an orientation of a mobile device. The orientation of the mobile device used to perform position-context dependent actions.

### FIELD OF THE INVENTION

The present invention relates to motion-based features, and more particularly to position-context based features.

### BACKGROUND

Portable electronic devices such as media players and mobile phones have ever increasing functionality. Mobile phones are becoming a user's main phone line as well as e-mail device, headline news source, web browsing tool, media capture and media presentation device. All of these functionalities have controls and settings that are currently activated through physical buttons and switches or ‘soft’ buttons and switches in the device's user interface. Some such devices are starting to include accelerometers.

### SUMMARY OF THE INVENTION

A method and apparatus to provide position-context based features. In one embodiment, the method includes determining a position of the device, and adjusting a response of the device based on the position.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A-C are diagrams showing some possible positions of a mobile device.

FIG. 2 is a network diagram of one embodiment of a system which may include the position-context based controls.

FIG. 3 is a block diagram of one embodiment of the position-context based control system.

FIGS. 4A and 4B are overview flowcharts of two embodiment of using position-context.

FIG. 5 is a flowchart of one embodiment of using position-context in a phone application.

FIG. 6 is a flowchart of one embodiment of using position context with commands.

### DETAILED DESCRIPTION

The method and apparatus described is for mobile device including position-context based controls or actions. The mobile device includes a position system, to determine the current orientation, position, and/or location of the device. For example, the positions may include: at ear, on table face down, on table face up, on table face x up (for a device with multiple stable orientations on a table or other flat surface), in holster, in cradle, for a mobile phone PDA. Similarly, for a game device the positions may be on the table, or in the hand, or various other positions. Note that the system discussed in the present application is applicable to all current phone form factors including flip phones, candy bar, sliders, etc. Furthermore, the system is also applicable to industrial designs that may have more stable orientations than just face down and face up. For example, a device shaped like a cube has six sides, any one of which may be provided as position context. The system is applicable to designs regardless of the actual number and configuration of the sides.

The system in one embodiment enables the use of a position-dependent command analysis. That is, a command may have a different meaning, depending on the position of the device when the command is issued. The system, in one embodiment, provides feedback such as vibration, visual feedback, and/or sound of a received command to the user.

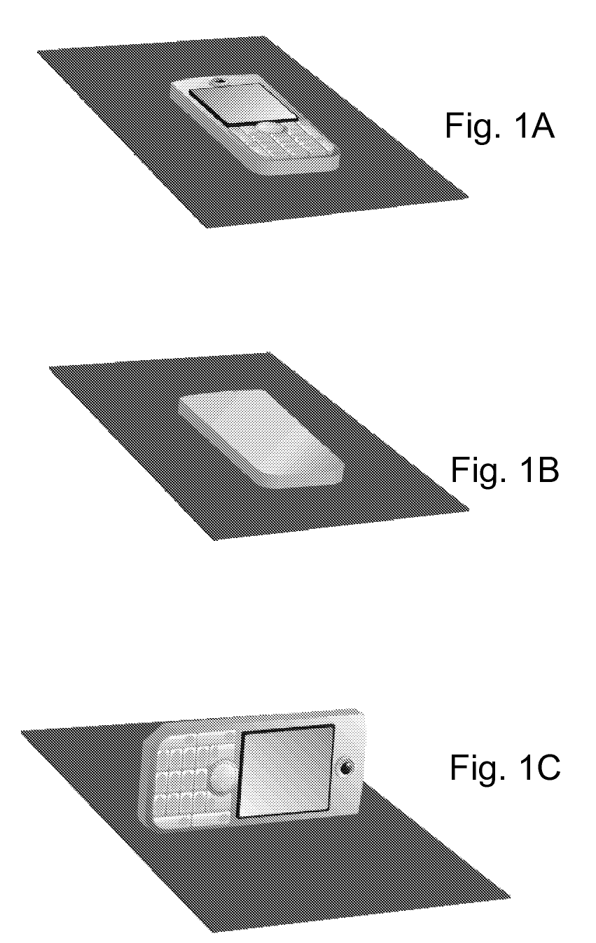

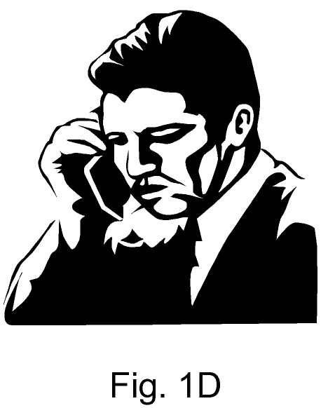

FIGS. 1A-D are diagrams showing some possible positions of a mobile device. As can be seen, the device may be laid on a table face up (FIG. 1A), face down (FIG. 1B), on its end (FIG. 1C), or may be held by a user (FIG. 1D). Alternate industrial designs of a device would allow many stable orientations with respect to a flat surface. Different features, and position context-based actions may become available, or may be automatically taken based on the current position of the device. In one embodiment, the accelerometer's orientation within the device is known. In one embodiment, there is an initialization performed for each device type by the manufacturer. As device OEMs each place the accelerometer in different locations on the device, in different orientations and each device has different mass, center of gravity etc, each device type is calibrated. However, once this calibration takes place, the user simply takes it out of the box, uses it and it works. The user does not have to go through any calibration, as the software has already been tailored for that model.

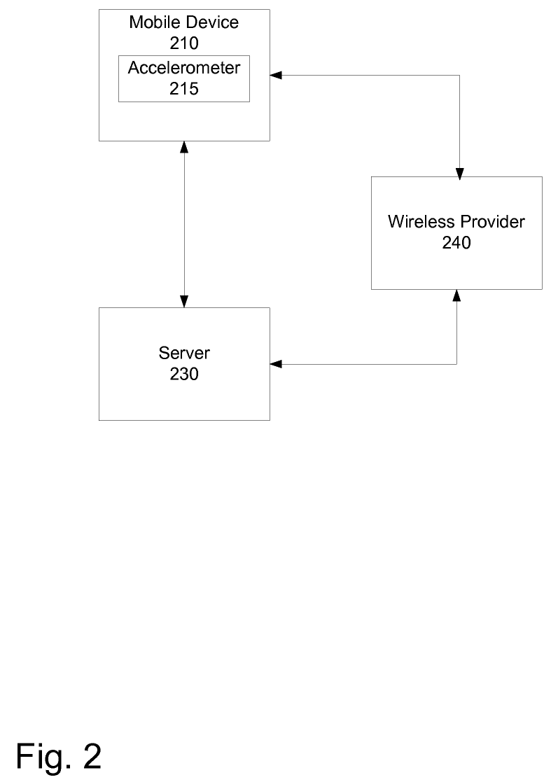

FIG. 2 is a network diagram of one embodiment of a system which may include the position-context based controls. The mobile device 210 includes an accelerometer 210, or similar movement detection logic, in one embodiment. In another embodiment, position detection logic may be included in the mobile device. The position detection logic 210 may be a sensor which detects the angle of the device (i.e. flat on front, back, upright, at an angle, etc.)

In one embodiment, the mobile device 210 may receive additional information from a server 230. The additional information may be used to analyze position, receive command data, or receive setting data.

In one embodiment, the user may interact with a wireless provider 240.

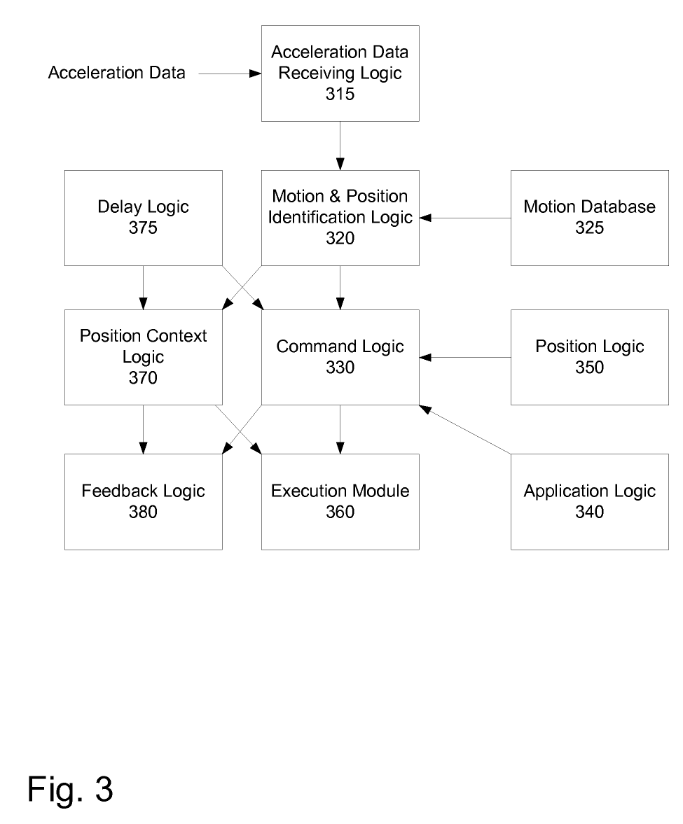

FIG. 3 is a block diagram of one embodiment of the position-context based control system. The system 310 receives acceleration data in acceleration data receiving logic 315. In one embodiment, acceleration data is received from an accelerometer. In one embodiment, the accelerometer is a three dimensional accelerometer. Alternatively, multiple accelerometers may be providing the acceleration data. In another embodiment, acceleration data may be received from another device.

The acceleration data is transferred to motion and position identification logic 320. Motion and position identification logic 320 identifies the motion of the device, if any. The motion of the device may indicate a motion command, a movement of the user that is unrelated, or a change in the position-context of the device. Motion and position identification logic 320 determines what the motion corresponds to.

In one embodiment, motion and position identification logic 320 also uses the acceleration data to determine the orientation of the device. In one embodiment, the orientation, or potential position contexts of the device include: on a stable surface, face up or face down, in motion, carried as the screen is being watched, etc. In one embodiment, the motion and position identification logic 320 continuously maintains a current “position context” data, and attempts to analyze the user's actions to identify the activity associated with the position context. For example, if the user is actively playing a game, while the device is being held at a particular angle, the position context may indicate that the user is playing a game, rather than merely indicating that the system is in a particular position. In one embodiment, motion and position identification logic 320 uses a motion database 325 to classify the motion data.

The motion and position identification logic 320 passes data identified as a motion command to command logic 330. Command logic 330 determines if the command has a position dependency. Certain commands may have a different meaning depending on position context, and/or application context. For example, a double shake may mean “skip to next song” when the user is listening to music, while the same double shake may mean “open a browser window” when the user is not utilizing any applications. Similarly, with respect to position context, a command may have a different meaning based on whether the device is in the holster, on the table, or in the user's hand.

If there are application-based differences in the command, the application logic 340 provides the currently active application data to the command logic. If there are position-context based differences, the position logic 350 provides current position context. The command logic 340 uses this data to identify the actual command issued by the user. The command logic 340 then passes the command to execution module 360. Execution module 360 executes the command, as is known in the art.

If the motion identified was a change of position context, the motion identification logic 320 passes it to position context logic 370. Position context logic 370 determines if the change in context should trigger a command. Certain changes in context, for example placing a phone face down during a phone conference, may trigger a command. If the position change triggers a command, position context logic 370 passes the command to execution module 360.

In one embodiment, position context logic 370 and/or command logic 330 may interact with delay logic 375. Delay logic enables the initiation of an action based on a position change that takes place some time after the actual position change. For example, if the position is face up on a table, in one embodiment after 5 seconds of no motion, a screen saver is initiated. In one embodiment, the screen saver may display user configurable information such as news headlines, stock quotes, or pictures. Thus, the position change triggers the delay logic 375. If no motion is received prior to the delay logic 375 indicating the action, the action is performed.

In one embodiment, system also includes feedback logic 380. Feedback logic 380 provides feedback to the user that a command has been identified. In one embodiment, feedback logic 380 uses the vibration capability of the mobile device to provide feedback. In one embodiment, audio feedback may be provided. In one embodiment, the feedback simply acknowledges the receipt of a command. In another embodiment, the feedback indicates the command received. In one embodiment, the feedback provides a limited amount of information. The use of the audio or motion feedback enables a user to utilize motion commands on the mobile device without having to view the screen. This provides a significantly larger pool of potential motions, as well as making the motions more natural to the user.

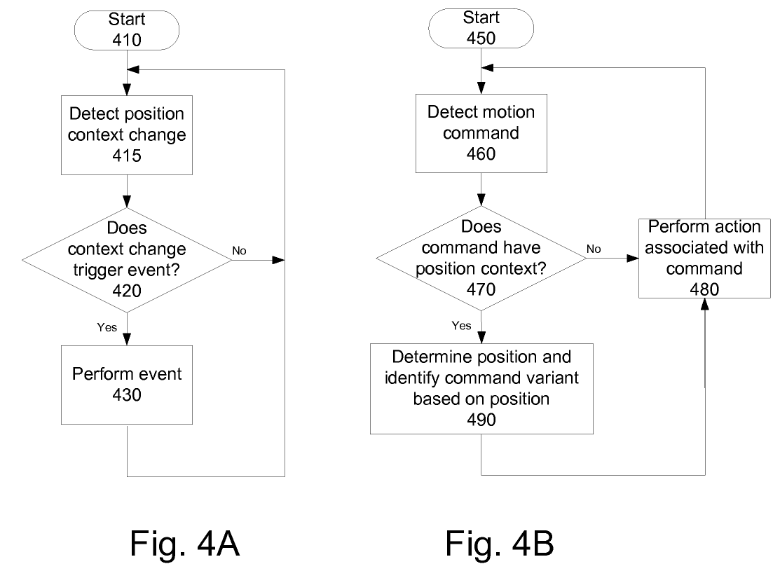

FIGS. 4A and 4B are overview flowcharts of two embodiment of using position-context. FIG. 4A illustrates a situation in which a position context change is detected, at block 415. When the position change context is detected, the process determines whether the context change triggers an event. The event may be a command. If no event is triggered, the process returns to monitoring the motion data. The position context data, maintained for the device, is updated, in one embodiment. If the context change does trigger an event, the action(s) associated with the event are performed, at block 430. The process then continues to monitor position context changes.

The events that may be triggered may be application specific events, such as switching to speaker phone, muting the phone, activating an application, answering a phone call, sending a call to voicemail, etc. or general events, such as going into max power save mode, turning off a display, turning on the device from sleep mode, changing a volume, etc.

FIG. 4B illustrates a situation in which the collected motion indicates a motion command, identified at block 460. The process, at block 470 determines whether the motion command has a position context. For example, a double tap may differ when the mobile device is on a table versus held to the ear. If there is a position context, the process continues to block 490. At block 490, the current position context is determined. The command variant associated with the current position context is identified. The process then continues to block 480 to execute the command variant identified. If the command was found not to have a position context, the process continues directly to block 480 to execute the command.

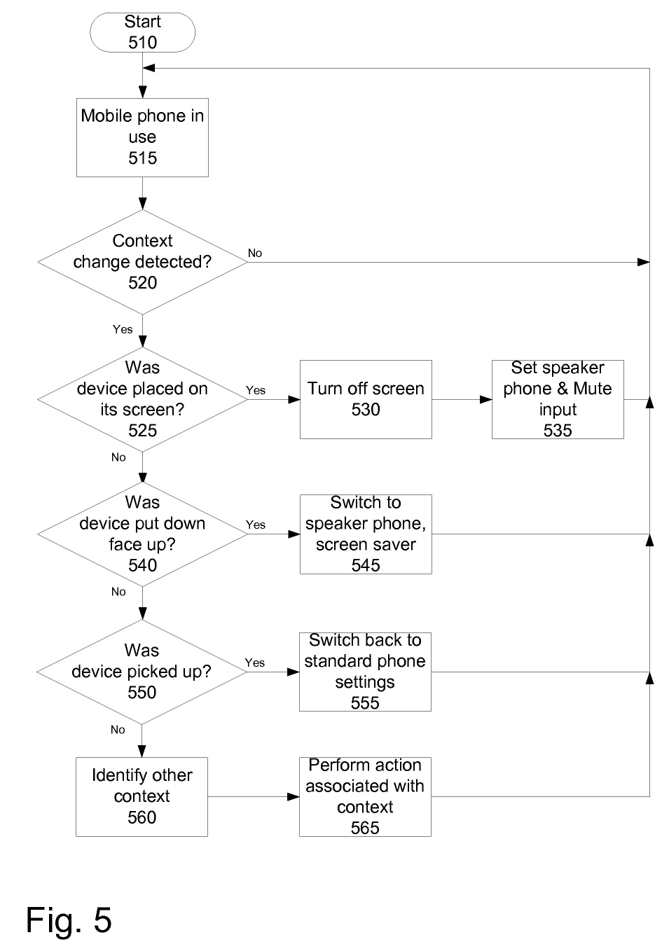

FIG. 5 is a flowchart of one embodiment of using position-context in a phone application. The process starts at block 510. In one embodiment, the process is always active when the mobile phone is in use, block 515.

At block 520, the process determines whether a context change has been detected. If no context change was detected, the process continues to monitor the motions of the user, and returns to block 515. If a context change was detected, the process continues to block 525.

At block 525, the process determines whether the context change was that the device was placed face down. If so, at block 530 the device is placed in a power saving mode. In power saving mode, unused hardware and software elements are turned off, powered down, or throttled back to reduce power consumption. For example, since the device is face down, there is no chance that the user is viewing the screen, so the screen is turned off. If there are no active applications that continue to work with the device face down (i.e. applications such as downloading, active telephone conversation, music player, etc.) the device may be sent into maximum power saver mode. Maximum power saver mode uses as little power as possible, while maintaining any active used applications. In addition to turning off the screen, the processor may also be placed in sleep mode. In one embodiment, if there are no active applications, the device is placed into a deep sleep mode, just awake enough to monitor for incoming events from the network or motion events. If there are active applications, those hardware and software elements of the mobile device that are not necessary for the active applications are turned off.

At block 535, the phone is switched to speaker phone, if it is not already on speaker phone. At block 535, input is muted. This enables the user to simply mute the call by placing the phone face down. This can be very useful as an indicator that the call is muted, on a conference call involving multiple people in the room. Furthermore, this is very useful because the user does not need to push multiple buttons. The process then returns to block 515, to continue monitoring motion.

If the position context change was not placing the phone face down, the process continues to block 540. At block 540, the process determines whether the device was placed on a surface with the face up. Being placed with the screen up can be distinguished from a user holding the device in the same position because when a user is holding a device there are some minor motions and vibrations inherent in the human physiology.

If the device was placed on a flat surface, face up, the process continues to block 545. At block 545, the device is switched to speaker phone. Generally speaking, when the user places the phone face up, he or she is no longer listening directly, and therefore the speaker phone should be initiated. The process then continues to block 515, to continue monitoring motions.

If the device was not placed face up, the process continues to block 550. At block 550, the process determines whether the device was picked up. If so, at block 555, the device is switched back to standard phone settings. This may include activating the screen, turning off the speaker phone. The process then continues to block 515, to continue monitoring motions. If the context change was not the device being picked up, the process continues to block 560.

At block 560, the alternative context is identified. At block 565, the action(s) associated with the context are performed. As noted above, the actions may range from any changes in the active applications on the device, in the basic configuration of the device, etc. The process then returns to block 515.

Note that the above flowchart assumes that there is no headset paired with the mobile phone. If there is a headset paired with the mobile phone, an alternate set of commands may be created by placing the phone in various positions. In one embodiment, the user may set preferences as to what occurs for various position contexts. In one embodiment, there are a set of default actions associated with each position context. In one embodiment, the user may alter these default actions. In another embodiment, the user may simply disable or enable these actions.

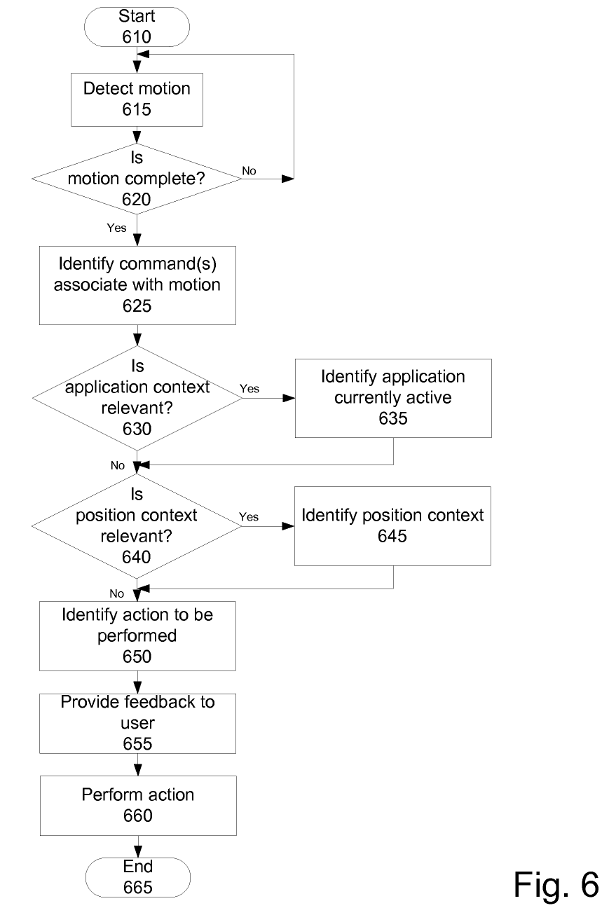

FIG. 6 is a flowchart of one embodiment of using position context with commands. The process, in one embodiment, is active whenever the user's device is active. In another embodiment, the user may disable the position context logic. The process monitors motion data, at block 615.

At block 620, the process determines whether the motion is complete. The motion is complete when a command is identified, or a position context change is registered. In one embodiment, this determination may be delayed slightly, to provide enough time for the processor to identify the motion and/or position context change.

If the motion is complete, the process continues to block 625. Otherwise, the process returns to block 615.

At block 625, the command associated with the motion is identified. The command may be a single command, such as “activate telephone application” or may be a series of commands, such as “activate download application, initiate highest priority download.”

At block 630, the process determines whether the application context is relevant to the command detected. If so, at block 635, the application currently active is identified. The process then continues to block 640. If the application context is not relevant, the process continues directly to block 640.

At block 640, the process determines whether the position context is relevant to the command detected. If so, at block 645, the position context is identified. The process then continues to block 650. If the application context is not relevant, the process continues directly to block 650.

At block 650, the action(s) to be performed are identified.

At block 655, feedback is provided to the user. The feedback, in one embodiment, tactile. In one embodiment, the tactile feedback is vibration feedback. In another embodiment, the feedback is auditory. In one embodiment, the feedback is visual. In one embodiment, the feedback may be a combination of these types of feedback. In one embodiment, the feedback only indicates that a motion command has been received. In another embodiment, the feedback provides additional information. For example, the feedback may provide a different signal for an action based on the associated application (e.g. a short vibration for an action acting on the mobile phone aspect, two short vibrations in a row for an action acting on a web browser aspect, etc.) In one embodiment, certain actions may have specific associated feedback. For example, if the user initiates a download it may have a separate feedback from any other browser-based action. In one embodiment, the user may program, modify, delete, or otherwise change the feedback mechanism.

At block 660, the action is performed. In one embodiment, the user has the opportunity to cancel the action after the feedback is received. In one embodiment, cancellation of the action may be done through a very simple motion. But if the action is not cancelled, it is performed by the system. The process then ends, at block 665. Note that in one embodiment, the system continuously monitors the motions received by the device. A thread such as the one shown in FIG. 6 is spawned for each action sequence that appears to be initiating a context change or a motion command, in one embodiment.

Therefore, the system in one embodiment provides the ability to have commands be position context modified. Furthermore, the system, in one embodiment, provides certain automatic functions based on the combination of a current device state and position context. Finally, in one embodiment, the system provides feedback to the user for received and identified motion commands. In one embodiment, the feedback does not need the user to visually verify the command.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
detecting a position context of the mobile device based on acceleration data; and
performing an action associated with the position context of the mobile device.

2. The method of claim 1, wherein the acceleration comprises a change in the position context of the mobile device, and the action is associated with the change of the position context from a first position to a second position.

3. The method of claim 1, wherein the acceleration comprises a motion command, and the action is associated with the motion command.

4. The method of claim 3, wherein the action associated with the motion command is independent of the position context.

5. The method of claim 1, wherein the mobile device is a mobile phone, and wherein the position context comprises one of: face down on a surface, face up on a surface, by an ear of a user, elsewhere.

6. The method of claim 5, wherein:
when the position context is face down, the mobile phone is set to speaker phone and mute;
when the position context is face up, the mobile phone is set to speaker phone.

7. The method of claim 1, further comprising:
when the position context of the mobile device indicates that the mobile device is face down on a surface, setting a power-saving mode to the mobile device, by turning off unused hardware and software elements of the mobile device.

8. The method of claim 1, further comprising:
providing non-visual feedback to the user regarding the motion command.

9. A mobile device including an acceleration sensor, the mobile device comprising:
a position logic to track a position context of a mobile device;
a motion identification logic to identify a motion of the mobile device; and
an execution logic to perform an action associated with the identified motion and the position context.

10. The device of claim 9, wherein the acceleration comprises a change in the position context of the mobile device, and the action is associated with the change of the position context from a first position to a second position.

11. The device of claim 9, further comprising:
a command logic to identify a command associated with the acceleration, wherein the action is associated with the motion command.

12. The device of claim 11, wherein the action associated with the motion command is independent of the position context.

13. The device of claim 9, wherein the mobile device is a mobile phone, and wherein the position context comprises one of: face down on a surface, face up on a surface, by an ear of a user, elsewhere.

14. The method of claim 14, wherein:
when the position context is face down, the mobile phone is set to speaker phone and mute;
when the position context is face up, the mobile phone is set to speaker phone.

15. The device of claim 9, further comprising:
when the position context of the mobile device indicates that the mobile device is face down on a surface, the execution module placing the device in a power saving mode, by turning off unused hardware and software elements.

16. The device of claim 9, further comprising:
a feedback logic to provide non-visual feedback to the user regarding the motion command.

17. The device of claim 9, further comprising:
a delay logic to enable a delayed execution of an action.

18. A method comprising:
identifying a change in a position context;
determining whether there is an action associated with the change in the position context; and
executing the action, when there is an action associated with the change in the position context.

19. The method of claim 18, further comprising:
determining a current active application;
determining an application-dependent action associated with the change in the position context; and
the executing the action comprising executing the application-dependent action.

20. A method comprising:
identifying a motion command;
determining a current position context;
determining an action associated with the motion command; and
executing the action.

21. The method of claim 20, wherein determining an action comprises:
determining an action based on one or more of: the current position context, a current active application, and the motion command.

22. A method comprising:
receiving acceleration data in a mobile device;
determining an action associated with the acceleration data;
providing feedback to the user, based on the determined action; and
executing the action.

23. The method of claim 22, wherein the acceleration data comprises one or more of: a motion command, and a position context.
